(19) United States
(12) Patent Application Publication
(10) Pub. No.: US 2025/0110206 A1
(43) Pub. Date: Apr. 3, 2025

(54) METHOD FOR FILTERING AND REMOVING FALSE TARGETS CAUSED BY SIDELOBES IN PULSE COMPRESSION FOR THE POLYPHASE P3-CODED WAVEFORM

(71) Applicant: VIETTEL GROUP, Ha Noi City (VN)

(72) Inventors: NHU THANH NGUYEN, Ha Noi City (VN); DINH KHUE NGUYEN, Bac Ninh City (VN); MANH TUAN NGUYEN, Ha Noi City (VN); XUAN THANH LE, Ha Noi City (VN); HONG VIET NGUYEN, Vinh Tuong District (VN)

(73) Assignee: VIETTEL GROUP, Ha Noi City (VN)

(21) Appl. No.: 18/899,862

(22) Filed: Sep. 27, 2024

(30) Foreign Application Priority Data
Oct. 3, 2023 (VN) 1-2023-06883

(51) Int. Cl. G01S 7/292; G01S 13/28

(52) U.S. Cl. CPC G01S 7/2927; G01S 13/288

(57) ABSTRACT

A method for filtering and removing false targets caused by sidelobes in pulse compression calculates the target filtering threshold to differentiate and eliminate false targets caused by sidelobes in pulse compression. It is applicable in radar signal processing systems using the polyphase P3-coded waveform (the P3 code) for both transmitted and received signals. This method leverages the characteristics of the P3 code's pulse compression output. Specifically, the sidelobes appear symmetrically on both sides of the main lobe, and the distance between the main lobe and the sidelobes is approximately equivalent to the pulse width of the transmitted signal, extending to both sides of the main lobe. For each pulse width of the signal, this distance is fixed and can be predetermined. Experimental results on radar systems have demonstrated that the proposed method effectively filters out all false targets caused by sidelobes in pulse compression.

### FIELD OF THE INVENTION

The invention refers to a method for implementing a filter to eliminate false targets caused by sidelobes in pulse compression for the polyphase P3-coded waveform. Specifically, the method for filtering and eliminating false targets caused by sidelobes in pulse compression is applied in pulse radars that use pulse compression techniques with transmitted and received signals using the polyphase P3-coded waveform.

### BACKGROUND OF THE INVENTION

The method for filtering and eliminating false targets caused by sidelobes in pulse compression is used in pulse radars that employ pulse compression techniques with transmitted and received signals utilizing the polyphase P3-coded waveform (the P3 code). This method eliminates false targets caused by sidelobes in pulse compression, thereby reducing the false alarm probability. It can also serve as a replacement for traditional methods that use window functions in pulse compression.

In a pulse radar system, the transmitter channel emits high-power pulse signals with a pulse width of τ and a pulse repetition interval of T (τ<T). The receiver channel captures signals reflected from targets in the space, and the signal processing system processes the received signals to provide target information. In the signal processing system of a pulse radar, the received signal, after passing through signal filters and being digitized, goes through the pulse compression block, the pulse accumulation block, and the target detection block. After passing through the pulse compression block, the signal's power is concentrated in the main lobe, which corresponds to the target's position relative to the radar, thereby increasing the signal-to-noise ratio at that location. However, a consequence of pulse compression processing is that the power also increases in the sidelobes, which are the areas surrounding the main lobe of the signal. When a target has a sufficiently large reflected power, the power concentrated in the main lobe, as well as in the sidelobes, can become significant. This increase in the signal-to-noise ratio in the sidelobes may lead to false alarms at these locations. The traditional method widely used to eliminate false targets caused by sidelobes in pulse compression is to apply a window function to the signal during pulse compression processing. While this method reduces the power of the sidelobes, thus eliminating false targets, it also decreases the power of the signal in the main lobe and increases the width of the main lobe, which may, in turn, reduce the radar's detection capability. The proposed method for filtering and eliminating false targets caused by sidelobes in pulse compression in this invention is applied to the P3 code. The method is based on the output characteristics after pulse compression, specifically the distance between the main lobe and sidelobes of the P3 code, to calculate the target classification threshold. At each location, the power of the received signal after pulse compression is compared to the target classification threshold. If the signal power is lower than the threshold, the location is classified as a sidelobe, and the target at that location is filtered out. Conversely, if the signal power is greater than the threshold, the location is classified as a possible main lobe, and the signal is passed through to the target detection block to determine the final target detection output. This proposed method effectively eliminates false targets caused by sidelobes in pulse compression, thereby reducing the radar's false alarm probability. Additionally, it does not increase the main lobe's width or decrease the signal-to-noise ratio, ensuring better resolution and target detection capability compared to traditional methods.

### Technical Nature of the Invention

The purpose of this invention is to propose a method for calculating the threshold to classify whether a target is located at the main lobe or the sidelobe in pulse compression, applicable to the signal processing system of pulse radars using the polyphase P3-coded waveform (the P3 code) for both transmission and reception. This classification aims to eliminate targets located at the sidelobes in pulse compression to reduce the radar's false alarm probability. To achieve this, the proposed method leverages the characteristics of the positions of the main lobe and sidelobes after pulse compression in the P3 code. Specifically, the sidelobes are symmetrically positioned on both sides of the main lobe, at a distance roughly equivalent to the pulse width of the transmitted signal. For each pulse width, this distance is fixed and can be predetermined.

Based on this characteristic, the proposed method for filtering and eliminating false targets caused by sidelobes in pulse compression for the P3 code involves the following steps:
Step 1: Gather information from the input signal for processing, including the signal power and the pulse width of the transmitted signal.
Step 2: Determine the characteristic distance between the main lobe and sidelobes corresponding to the transmitted pulse width.
Step 3: Calculate the target classification threshold at each range cell of the signal.
Step 4: Compare the power at the current range cell with the target classification threshold and output the result based on two scenarios:
   If the power is less than the threshold: Identify this as a sidelobe power position and filter out the target at this location.
   If the power is greater than the threshold: Identify this as a possible main lobe position of the target and continue calculating and comparing it with the target detection threshold to determine the final output-whether or not there is a target at this location.

### BRIEF DESCRIPTION OF THE DRAWINGS

FIG. 1. Description of the main components of a pulse radar system using the sidelobe target elimination filtering method.

FIG. 2. The polyphase P3-coded waveform with the bandwidth of B=2 MHz and the sampling pulse length of N=100.

FIG. 3. Description of the positional correlation between the main lobe and the sidelobes of the pulse compression output for the polyphase P3-coded waveform with bandwidth of B=2 MHz and the sampling pulse length of N=100.

FIG. 4. Description of the positional correlation between the main lobe and the sidelobes of the pulse compression output for the polyphase P3-coded waveform with different sample pulse lengths.

FIG. 5. Description of the target classification threshold calculation process.

FIG. 6. Actual thresholds of target classification.

### DETAILED DESCRIPTION OF THE INVENTION

The method for filtering and eliminating false targets caused by sidelobes in pulse compression is used in pulse radar systems that employ pulse compression techniques with transmitted and received signals utilizing the the polyphase P3-coded waveform (the P3 code). This method eliminates false targets caused by sidelobes in pulse compression, thereby reducing the false alarm probability. It can also replace traditional methods to ensure the radar's resolution and target detection capability.

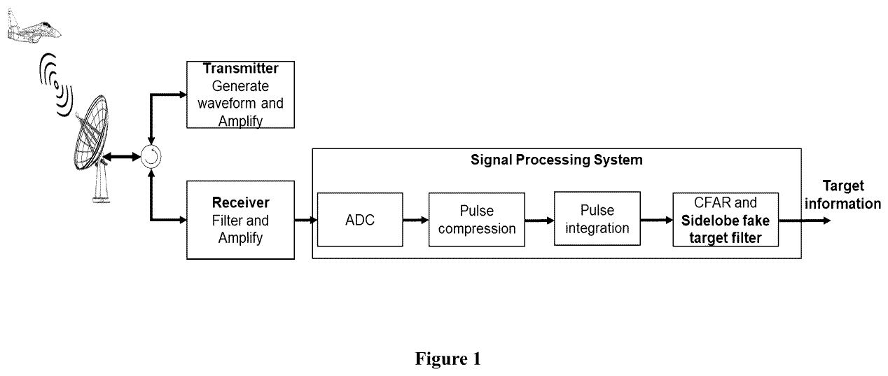

FIG. 1 provides an overview of the components of the pulse radar system applying the proposed method in this invention. The system includes the following main components:
Antenna system: The antenna transmits radio waves into a narrow beam, directing the energy towards a specific target area and receives radio signals reflected from objects in space.
Transmitter Channel System: This system generates modulated waves with a pulse width of τ and a repetition period of T and amplifies the signal before it reaches the antenna.
Receiver Channel System: This system receives the reflected signals from targets in space. The received signals are then passed through signal filters and amplifiers.
Signal Processing System: This system processes the received signals to provide target information (e.g., position, velocity, target signal power, etc.). The functional blocks of the signal processing system include:
   Signal Digitization Block: This block converts the signal from analog to digital form by using an ADC (Analog to Digital Converter). For the P3 code, the digitized signal before the pulse compression block has a sampling frequency equal to the bandwidth of the transmitted signal.
   Pulse Compression Block: This block performs a correlation between the received signal and the transmitted signal to compress the received signal in the time domain, providing information about the target's position.
   Pulse Train Accumulation Block: This block accumulates the received signal over a pulse train. A pulse train of Nₚᵤₗₛₑ pulses (Nₚᵤₗₛₑ>1) with phase correlation undergoes a Discrete Fourier Transform (DFT) to analyze the signal in the frequency domain, providing information about the target's velocity.
   Target Threshold Determination Block: This block calculates the power threshold to determine the target. It employs two threshold filters: one to classify and filter out targets at sidelobe positions and another CFAR (Constant False Alarm Rate) filter to stabilize the false alarm probability for target detection.

The P3 code used in the radar system, to which the proposed method in this invention is applied, has a signal representation equation as follows:

$$x ( t ) = A {e}^{j ( 2 π {f}_{c} t + {ϕ}_{n} )} , 0 \leq t < τ$$

Where A is the signal amplitude, f_{c} is the carrier frequency, τ is the pulse width, and Øn is the phase modulation function.

The phase modulation function ϕₙ in the equation representing the P3 code is essentially a sequence of sampled phase values of the Linear Frequency Modulation (LFM) signal over a time period equal to the pulse width. For an LFM signal with bandwidth BBB, the signal equation is:

$${x}_{L F M} ( t ) = {Ae}^{[ j ( π \frac{B}{T} {t}^{2} ) ]} , 0 \leq t < τ$$

Sampling the phase of the LFM signal at a sampling frequency equal to the signal bandwidth, the phase modulation sequence of the P3 code is represented as follows:

$$\begin{matrix}{ϕ}_{n} = π \frac{B}{T} {( n \times \frac{1}{B} )}^{2} \\ = \begin{matrix}\frac{π}{N} {n}^{2} , & n = 0 , 1 , … , ( N - 1 )\end{matrix}\end{matrix}$$

Where N=Bτ is the pulse length in terms of samples.

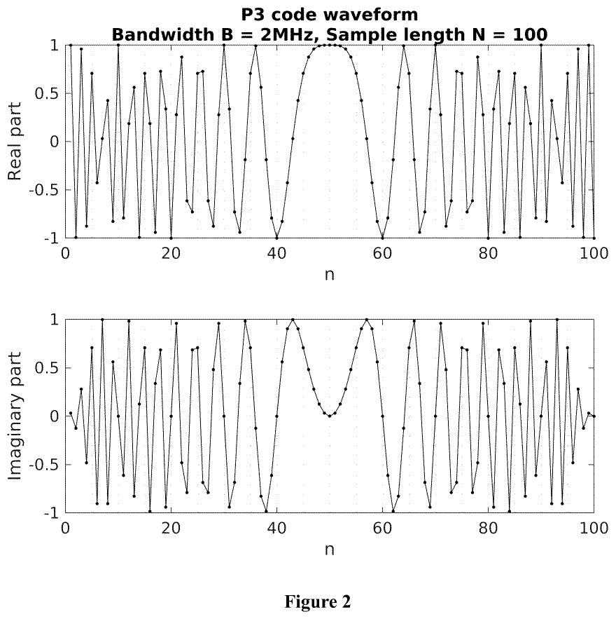

Referencing FIG. 2, it describes the modulation of the I channel (real part) and the Q channel (imaginary part) of the P3 coded signal with signal bandwidth of B=2 MHz and the sampling pulse length of N=100.

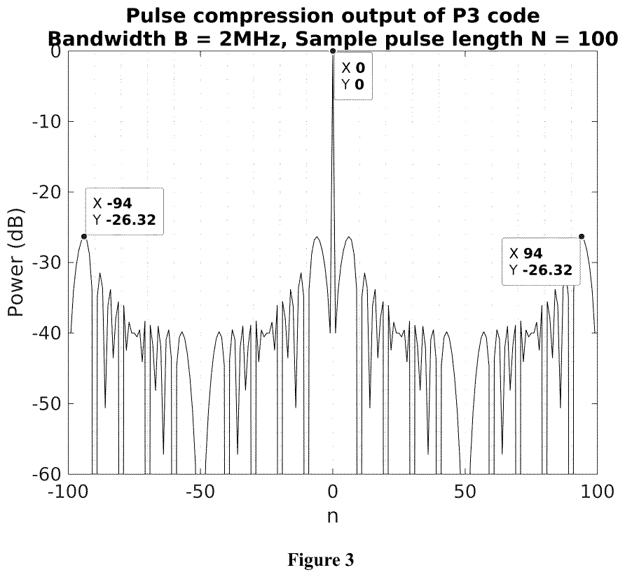

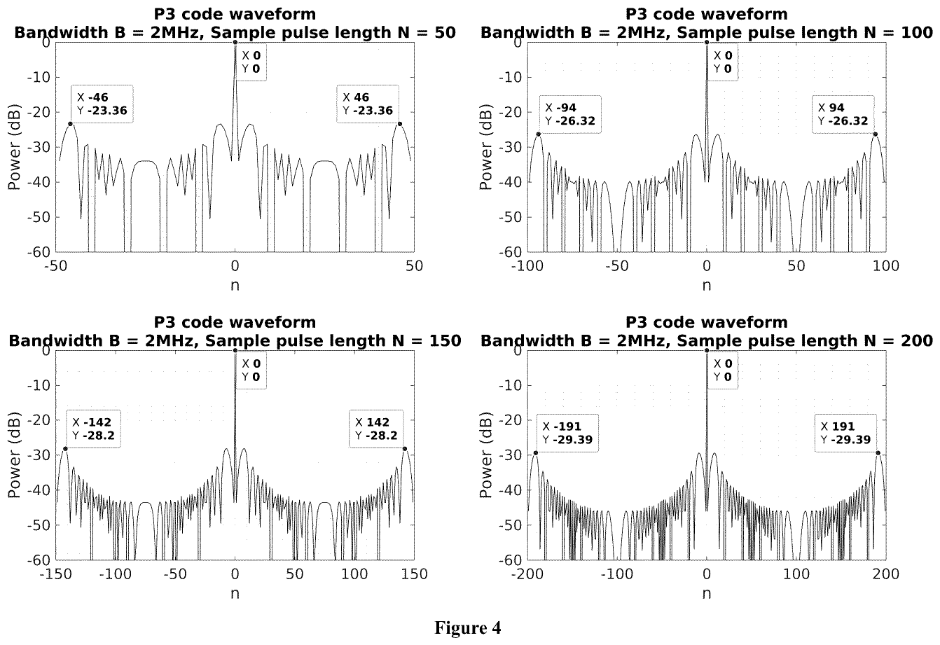

For the P3 phase modulation code, the output after pulse compression exhibits certain characteristics of the sidelobes as follows:
The sidelobes appear symmetrically on both sides of the main lobe. The position of the sidelobe with the highest power is located at a distance approximately equal to the pulse width from the position of the main lobe. FIG. 3 illustrates the positions of the main lobe and the sidelobes in pulse compression for the P3 code.
For each pulse length in terms of samples, the distance from the main lobe to the sidelobes is fixed and can be predetermined. FIG. 4 depicts the positions of the main lobe and sidelobes in pulse compression for the P3 code with different sample pulse lengths.
As the pulse length in terms of samples increases, the peak sidelobe level (PSL), which is the ratio of the peak of the largest sidelobe to the main lobe, decreases.

Based on the characteristic distance between the main lobe and the sidelobes, the proposed method for eliminating false targets caused by sidelobes in pulse compression for the P3 code includes the following steps:
Step 1: Gather the input signal information for processing, including the signal power and the pulse width of the transmitted signal.
Step 2: Determine the characteristic distance between the main lobe and the sidelobes corresponding to the pulse width of the transmitted signal. For each pulse length in terms of samples N, the distance K in sampling points between the main lobe and the sidelobes in the pulse compression output of the P3 code is fixed. This value can be determined through simulation for different pulse widths and stored in a corresponding lookup table.
Step 3: Calculate the target classification threshold at each range bin of the signal. The target classification threshold is calculated as the average power of the range bins within a window on both sides (left and right) of the range bin being considered, with a distance equal to K sampling points from the position of the range bin being considered. The formula for calculating the target classification threshold is as follows:

$${P}_{t h r e s h o l d} = \frac{1}{2} ( \frac{{\sum }_{i = 1}^{W} {P}_{L i}}{W} + \frac{{\sum }_{i = 1}^{W} {P}_{R i}}{W} )$$

### Where:

P_{Li}, P_{Ri} represent the power of the range bins within the window region located on both sides of the range bin being considered, and at a distance of K sampling points from the range bin being considered.
W is the width of the window region used for averaging the range bins.

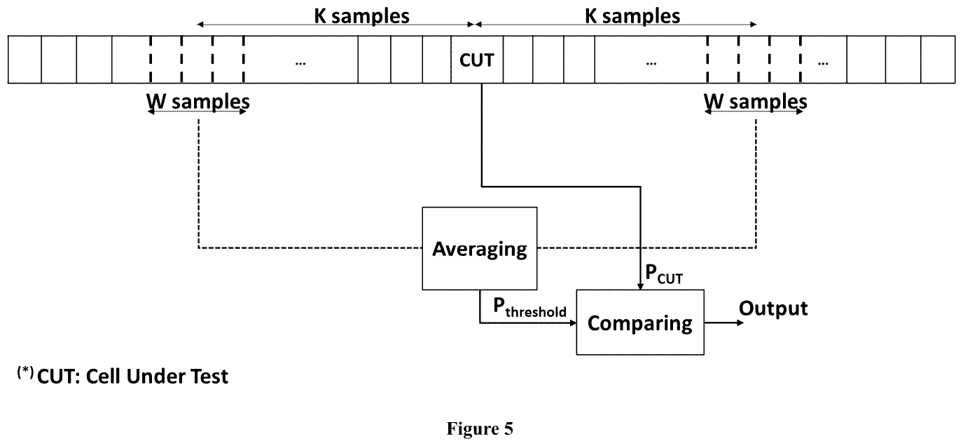

Referencing FIG. 5, which illustrates the process for calculating the target classification threshold:
Step 4: Compare the power at the range bin being considered with the target classification threshold and determine the output based on the following two cases:
   If the power is less than the threshold: This is identified as the position of the sidelobe power, and the target at this position is filtered out.
   If the power is greater than the threshold: This may be identified as the position of the main lobe of the target. Continue to calculate and compare with the target detection threshold to determine the final output, indicating whether there is a target at this position or not.

### Achieved Results of the Invention

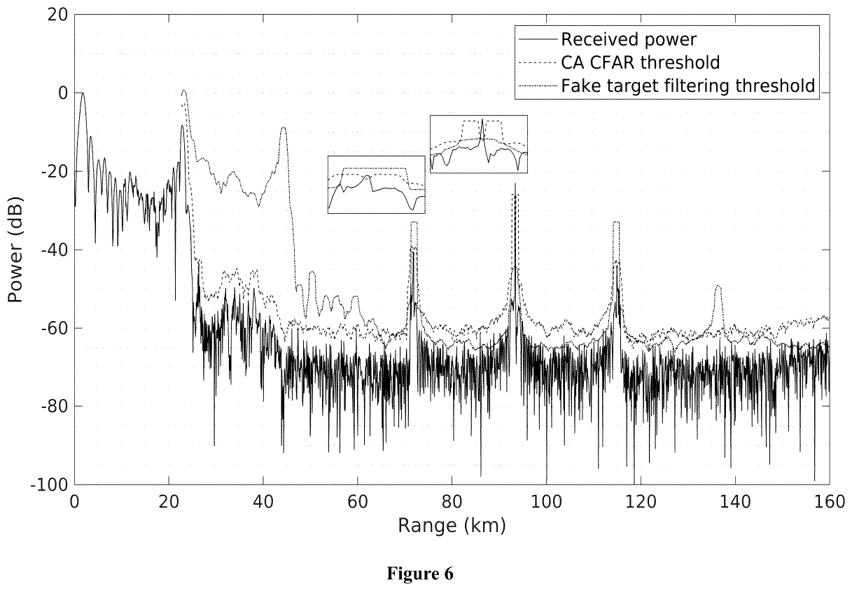

Experimental results on a pulse-Doppler radar system demonstrate that this new method can eliminate 100% of false targets caused by sidelobes in pulse compression. The real-world result of target detection and sidelobe fake target elimination is illustrated in FIG. 6.

The following are the comparison results of the signal loss at the main lobe between the method described in this invention and several common window functions used in traditional methods:

| | Main Lobe | Range Detection |
|---|---|---|
| Method | Power Loss | Capability Degradation |
| The proposed method in this | 0 dB | 0% |
| invention | | |
| Hamming Window | −2.7 dB | −14.4% |
| Hanning Window | −3 dB | −15.8% |
| Chebyshev Window | −3.2 dB | −16.8% |
| Blackman Window | −3.8 dB | −19.6% |

The comparison results indicate that the proposed method offers better target detection capability compared to various window functions used in traditional methods. Therefore, this method can be practically implemented to eliminate false targets caused by sidelobes in pulse compression and enhance the detection capability of radar systems.

1. A method for filtering and removing false targets caused by sidelobes in pulse compression for the polyphase P3-coded waveform (the P3 code), which involves calculating thresholds to classify and eliminate false targets caused by sidelobes in pulse compression, applicable in radar signal processing systems using the P3 code signals utilizes the characteristic positions of a main lobe and sidelobes after pulse compression; The pulse-compressed signal output has the following sidelobe characteristics:
the sidelobes appear symmetrically on both sides of the main lobe;
the position of the sidelobe with a highest power is located at a distance approximately equal to a pulse width from the main lobe;
for each pulse length in terms of samples, a distance between the main lobe and the sidelobes is fixed and can be predetermined;
as the pulse length in terms of samples increases, a peak sidelobe level (PSL) decreases.

2. The method according to claim 1, wherein the filtering and removal of false targets caused by sidelobes in pulse compression for the P3 code involves determining the distance between the main lobe and sidelobes corresponding to the pulse width and performing the following steps:
Step 1: obtain an input signal information for processing, including a signal power and a pulse width of a transmitted signal;
Step 2: for each pulse length in terms of samples N of the P3 code, a distance K in sampling points between the main lobe and the sidelobes in the pulse compression output of the P3 code is fixed; This value can be determined through simulation for different pulse widths and stored in a corresponding lookup table;
Step 3: for each range bin of the signal, calculate a target classification threshold, the target classification threshold is calculated as an average power of range bins within a window on both sides (left and right) of the range bin being considered, at a distance of K sampling points from a position of the range bin being considered, the formula for calculating the target classification threshold is as follows:
$${P}_{t h r e s h o l d} = \frac{1}{2} ( \frac{{\sum }_{i = 1}^{W} {P}_{L i}}{W} + \frac{{\sum }_{i = 1}^{W} {P}_{R i}}{W} )$$
where:
P_{Li}, P_{Ri} represent the power of the range bins within a window region located on both sides of the range bin being considered, and at a distance of K sampling points from the range bin being considered;
W is a width of the window region used for averaging the range bins;
Step 4: compare the power at the range bin being considered with the target classification threshold and determine an output based on the following two cases:
if the power is less than the threshold: this is identified as the position of the sidelobe power, and the target at this position is filtered out;
if the power is greater than the threshold: this may be identified as the position of the main lobe of the target, continue to calculate and compare with the target detection threshold to determine a final output, indicating whether there is a target at this position or not.
